(19) United States
(12) Patent Application Publication
(10) Pub. No.: US 2015/0266127 A1
(43) Pub. Date: Sep. 24, 2015

(54) ARC WELDING APPARATUS WITH TRIGGER

(71) Applicants: Darren PHILL, Calgary (CA); Chris RIEMER, Calgary (CA)

(72) Inventors: Darren PHILL, Calgary (CA); Chris RIEMER, Calgary (CA)

(21) Appl. No.: 14/664,332

(22) Filed: Mar. 20, 2015

Related U.S. Application Data
(60) Provisional application No. 61/968,301, filed on Mar. 20, 2014.

(51) Int. Cl. B23K 9/28

(52) U.S. Cl. CPC B23K 9/282

(57) ABSTRACT

There is disclosed an arc welding apparatus with an integrated trigger which is adapted to allow a consumable electrode rod or stick to be quickly replaced with a simple operating motion. In an embodiment, the integrated trigger is adapted to be operated by one hand to actuate a retention lever. The retention lever is pivotally mounted within a head stock or frame, and adapted to removably hold in position a consumable electrode rod during an arc welding operation. The pivotally mounted retention lever is connected to a resiliently compressible biasing means, such as a compression spring, which applies a rotating force against the pivotally mounted retention lever to hold the consumable electrode rod against an inner retention surface of the head stock.

### FIELD OF THE INVENTION

The present invention relates generally to the field of welding, and more particularly to an improved welding apparatus with a trigger.

### BACKGROUND

Arc welding is a common means of connecting two metal parts at a welding joint by utilizing a power supply to create an electric arc between an electrode and a base metal. The welding process melts the metals at a welding point to fuse the two metal parts together and provides a strong, structural bond.

A common type of arc welding uses a consumable rod or stick as the electrode, which is also commonly known as stick welding. In this type of welding, the consumable electrode rods or sticks must be frequently replaced as they melt and become consumed by the welded joint. While stick welding is versatile and produces very strong welds, with existing arc welding tool designs, stick welding can be very slow due to the frequent need to replace the consumable tip, sometimes as often as every minute of welding operation or less. A commonly required operation with existing arc welding tools is to twist the handle of the arc welding tool in order to allow a pin extending through a neck portion of the tool to actuate a retention lever in the head of the arc welding tool, thereby releasing a used electrode rod with a new one. This operation can become cumbersome and tiring if done repeatedly.

Therefore, what is needed is an improve arc welding apparatus which overcomes some of the limitations of prior art arc welding tools.

### SUMMARY

The present disclosure relates to an arc welding apparatus with an integrated trigger which is adapted to allow a consumable electrode rod or stick to be quickly replaced with a simple trigger operating motion.

In an embodiment, the integrated trigger is adapted to be operated by one hand to actuate a retention lever. The retention lever is pivotally mounted within a head stock or frame, and adapted to removably hold in position a consumable electrode rod during an arc welding operation. The pivotally mounted retention lever is connected to a resiliently compressible biasing means, such as a compression spring, which applies a rotating force against the pivotally mounted retention lever to hold the consumable electrode rod against an inner retention surface of the head stock.

In an embodiment, the head stock is a metallic conductor which draws current from a power source electrically connected to an electrically conductive mounting base and an electrically conductive neck rod connecting the head stock to the mounting base.

In another embodiment, the retention lever and the trigger may also be metallic to provide structural strength, and may be electrically conductive, although in this case the trigger would be covered by an electrically insulative overmold to prevent the possibility of any electrical shock.

In another embodiment, the trigger includes a curved cam profile adapted to slidably engage a surface of the retention lever, such that a smooth trigger pulling action allows the retention lever to release a used consumable electrode rod, and to allow quick insertion of another consumable electrode rod in its place. An opening to the head stock can be suitably shaped to help guide the tip of the consumable electrode rod into position.

Advantageously, this novel quick release trigger design allows used consumable electrode rods to be quickly replaced with a new one, and by allowing a single handed operation of the arc welding apparatus with minimal effort to squeeze a trigger, the speed of arc welding with a consumable electrode tip can be significantly improved.

In this respect, before explaining at least one embodiment of the invention in detail, it is to be understood that the invention is not limited in its application to the details of construction and to the arrangements of the components set forth in the following description or the examples provided therein, or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The present invention will be better understood and objects of the invention will become apparent when consideration is given to the following detailed description thereof. Such description makes reference to the annexed drawings wherein:

FIGS. 1A and 1B are exemplary views of an arc welding apparatus in accordance with an illustrative embodiment.

FIG. 2 is an exemplary close-up isometric view of the arc welding apparatus in accordance with an illustrative embodiment.

FIGS. 3A and 3B are exemplary partial cut-out views of a head, neck and mounting base assembly incorporating a trigger in accordance with an illustrative embodiment.

FIG. 3C is an exemplary view of the trigger arm of FIGS. 3A and 3B in accordance with an illustrative embodiment.

FIGS. 4A and 4B are exemplary views of the arc welding apparatus in operation in accordance with an illustrative embodiment.

FIGS. 5A and 5B are exemplary isometric views of a head stock, and the head stock shown in a head, neck and mounting base assembly in accordance with an illustrative embodiment.

FIGS. 6A and 6B show exemplary side views of the head, neck, mounting base and trigger assembly with and without the head casing.

FIGS. 7A and 7B are exemplary side views of the head, neck, mounting base, trigger, and insulative casings and overmolds providing a protective outer shell in accordance with an illustrative embodiment.

FIGS. 8A and 8B show exemplary side views of the head, neck, mounting base, trigger assembly and head casing, with and without the overmold.

FIGS. 9A and 9B show exemplary views of an alternative embodiment in which the trigger and retention lever are a single, integrated unit rather than two separate pieces.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

As noted above, the present disclosure relates to an arc welding apparatus with an integrated trigger which is adapted to allow a consumable electrode rod or stick to be quickly replaced with a simple operating motion.

In an embodiment, the integrated trigger is adapted to be operated by one hand to actuate a retention lever. The retention lever is pivotally mounted within a head stock and adapted to removably hold in position a consumable electrode rod during an arc welding operation. The pivotally mounted retention lever is connected to a resiliently compressible biasing means, such as a compression spring, which applies a rotating force against the pivotally mounted retention lever to hold the consumable electrode rod against an inner retention surface of the head stock.

In an embodiment, the head stock is a metallic conductor which draws current from a power source electrically connected to an electrically conductive mounting base and an electrically conductive neck rod connecting the head stock to the mounting base.

In another embodiment, the retention lever and the trigger may also be metallic to provide structural strength, and may be electrically conductive, although in this case the trigger would be covered by an electrically insulative overmold to prevent the possibility of any electrical shock.

In another embodiment, the trigger includes a curved cam profile adapted to slidably engage a surface of the retention lever, such that a smooth trigger pulling action allows the retention lever to release a used consumable electrode rod, and to allow quick insertion of another consumable electrode rod in its place. An opening to the head stock can be suitably shaped to help guide the tip of the consumable electrode rod into position.

Advantageously, this novel quick trigger release built directly into the arc welding apparatus allows used consumable electrode rods to be quickly replaced with a new one, and by allowing a single handed operation of the integrated trigger with minimal effort, the speed of arc welding with multiple consumable electrode tips can be significantly increased.

An illustrative embodiment will now be described in more detail with reference to the drawings.

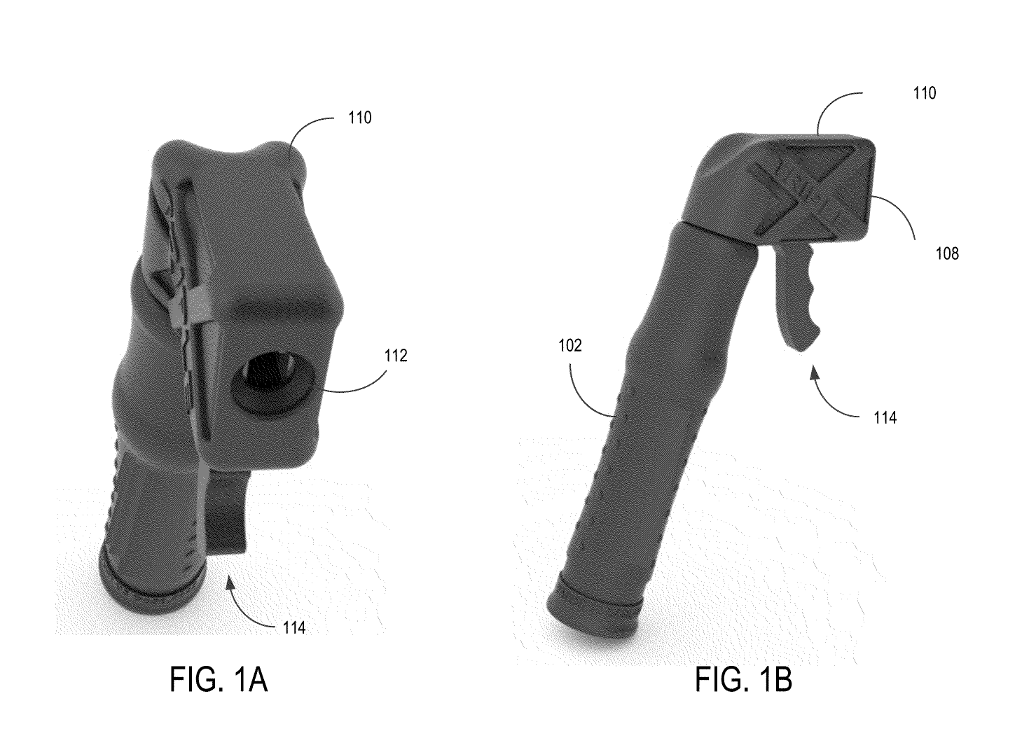

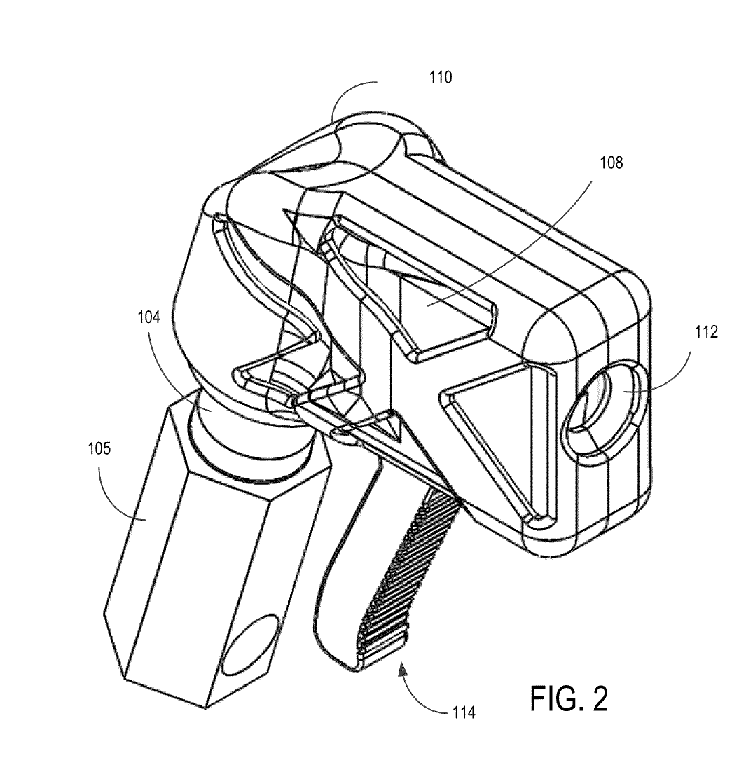

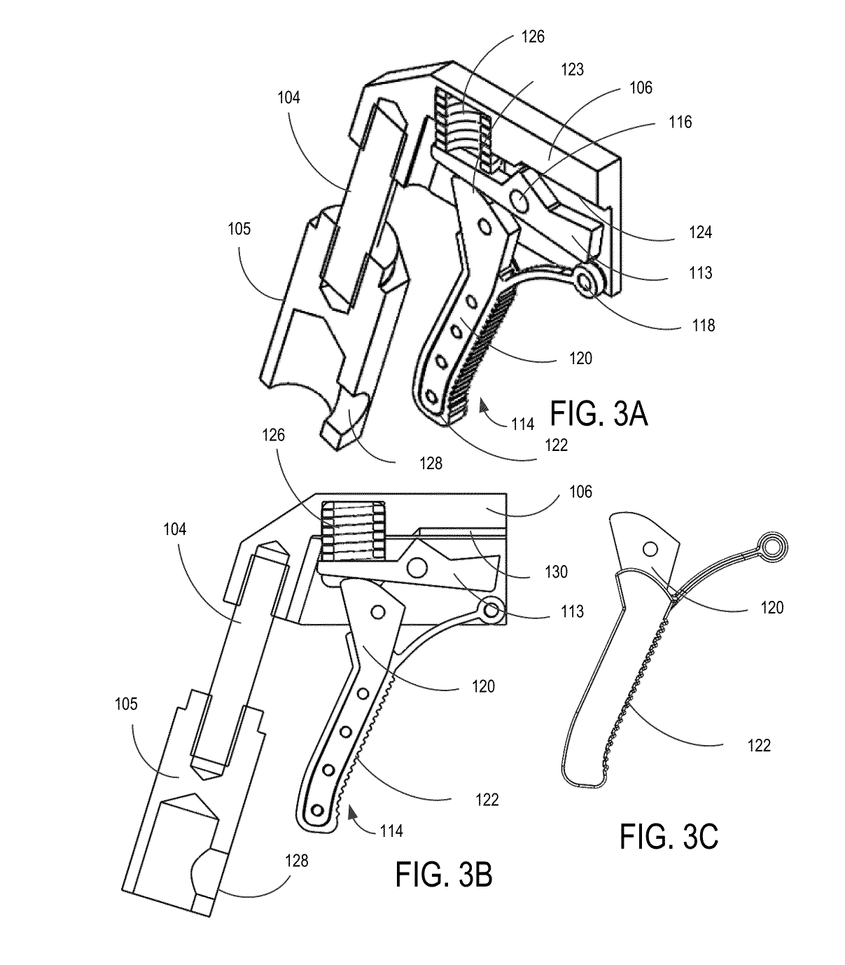

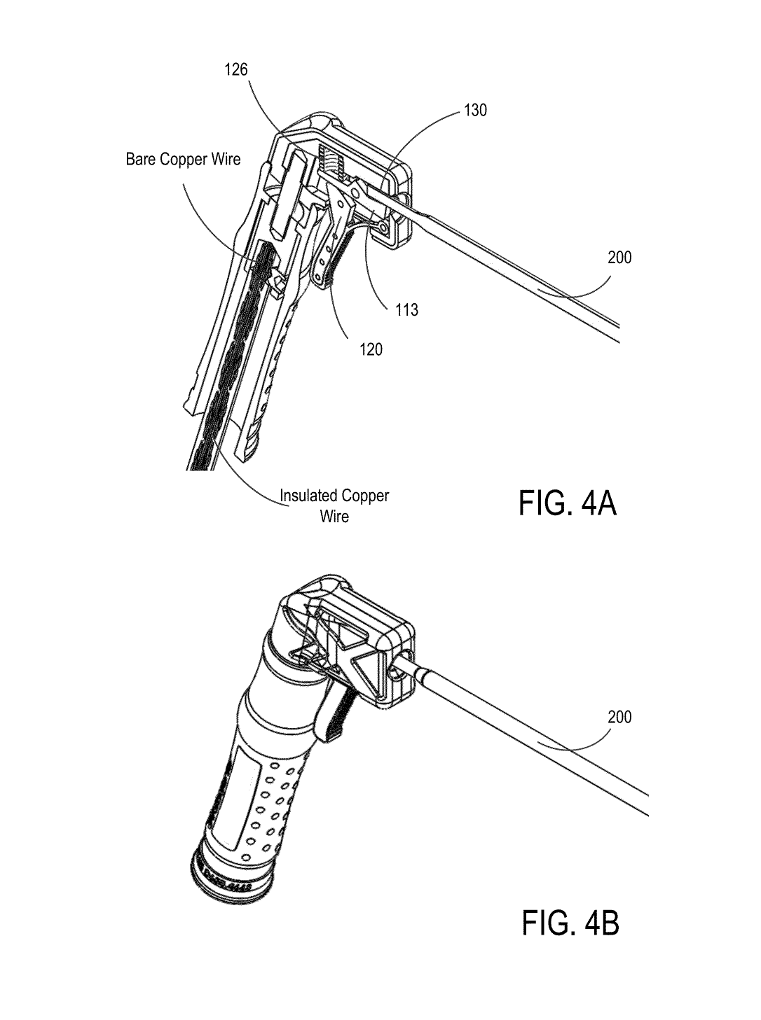

Shown in FIGS. 1A and 1B are exemplary views of an arc welding tool in accordance with an illustrative embodiment. In this illustrative example, the apparatus is shown with a handle 102 which fully covers a mounting base 105 (see FIG. 2) and a neck 104 (see FIG. 2) which joins the mounting base 105 to a head stock or frame 106. In use, the head stock 106 is also fully encased in a clam shell 108, for example, and may further include an overmold 110 or an outer shell over the clam shell 108 which provides greater protection against mechanical shocks by utilizing a softer, more flexible material than the harder clam shell 108 encasing the head stock 106. As shown in FIG. 1A, an opening 112 allows a consumable electrode rod (see FIGS. 4A & 4B) to be received by a retention lever 113 (see FIG. 3A). A trigger 114 enables operation of this retention lever 113, as will be described in further detail below.

Now referring to FIG. 2, shown is an exemplary isometric view of a head, neck 104 and mount assembly 105 in which the head stock/frame 106 is covered by an insulative clam shell 108 and further covered by an overmold 110 in accordance with an illustrative embodiment. In this view, an opening 112 is shown at the front of the head, into which a consumable electrode rod or stick can be inserted while the trigger 114 is being squeezed and the retention lever 113 (FIG. 3A) is being held open. If the trigger 114 is not being squeezed, either a consumable electrode rod or stick is already being held in position, or a consumable electrode rod or stick cannot be inserted.

In a preferred embodiment, the opening 112 which receives the consumable electrode rod or stick is suitably shaped to help guide the consumable electrode rod or stick into proper position to be inserted. For example, the opening 112 may have a funnel shaped rim which further narrows and guides a consumable electrode rod or stick being inserted into the opening.

FIGS. 3A and 3B are exemplary partial cut-away views of a head stock 106, neck 104 and mounting base 105 incorporating a trigger 114. neck 104 may be threaded to engage and mount the head stock 106 at a top end, and mounting base 105 at a bottom end. Mounting base 105 may be secured to a conductive wire utilizing a set screw within a set screw aperture 128, for example.

As shown, trigger 114 may comprise an arm 120 which is covered by an insulative arm overmold 122. Here, trigger 114 engages a retention lever 113 which is pivotally mounted at pivot 116 to the head stock or frame 106. The arm 120 of trigger 114 is also pivotally mounted at pivot 118 to the head stock 106.

Once assembled as shown, the neck 104 can provide a solid structural connection which keeps the assembly rigid in use. Furthermore, as the mounting base 105, neck 104, and head stock 106 are at least partially electrically conductive metals which form a conductive path, an electrical power source connected to the mounting base 105 can provide a current to a consumable electrode rod or stick being held by the retention lever 113.

In operation, the retention lever 113 is urged to rotate against an inner retention surface 124 of the head stock 106 by a resiliently compressible biasing means 126, such as a compression spring, to hold in position a consumable electrode rod or stick. The inner retention surface 124 may be suitably shaped to hold the consumable electrode rod or stick securely. For example, the inner retention surface 124 may provide a retention surface 124 which allows the consumable electrode rod or stick to be secured by up to three surfaces.

In operation, when the trigger 144 is squeezed by an operator using one or more fingers, the retention lever 113 is pivoted to open and release any used consumable electrode rod or stick being held against the inner retention surface 124 of the head stock 106.

In an embodiment, a cam surface 123 may be provided on arm 120 such that a squeezing action on the trigger 114 allows leveraged force to be slidably applied to the retention lever 113.

In another embodiment, the trigger arm 120 shown in FIG. 3C may also be made of a metal material to provide structural strength, in which case it will need to be encased in an electrically insulative overmold 122 to avoid an electric shock. However, it will be appreciated that the trigger arm 120 can also be at least partially made of a non-conductive material to further reduce the possibility of an electrical shock.

Now referring to FIG. 4A, shown is a partial cut-away view of the entire arc welding apparatus assembly in use, in which the head stock is holding a consumable electrode rod or stick 200 in between the retention lever and a retention surface of the head stock. The mounting base also shows an insulated copper wire, with an extending bare wire portion electrically connected to the mounting base by a set screw, or other mounting means. As described above, a continuous electrically conductive path is formed by the mounting base, the neck, and the head stock which is holding the consumable electrode rod or stick 200. FIG. 4B shows a corresponding outer view of the arc welding apparatus of FIG. 4A, and better illustrates that the consumable electrode rod or stick 200 is generally cylindrical in shape.

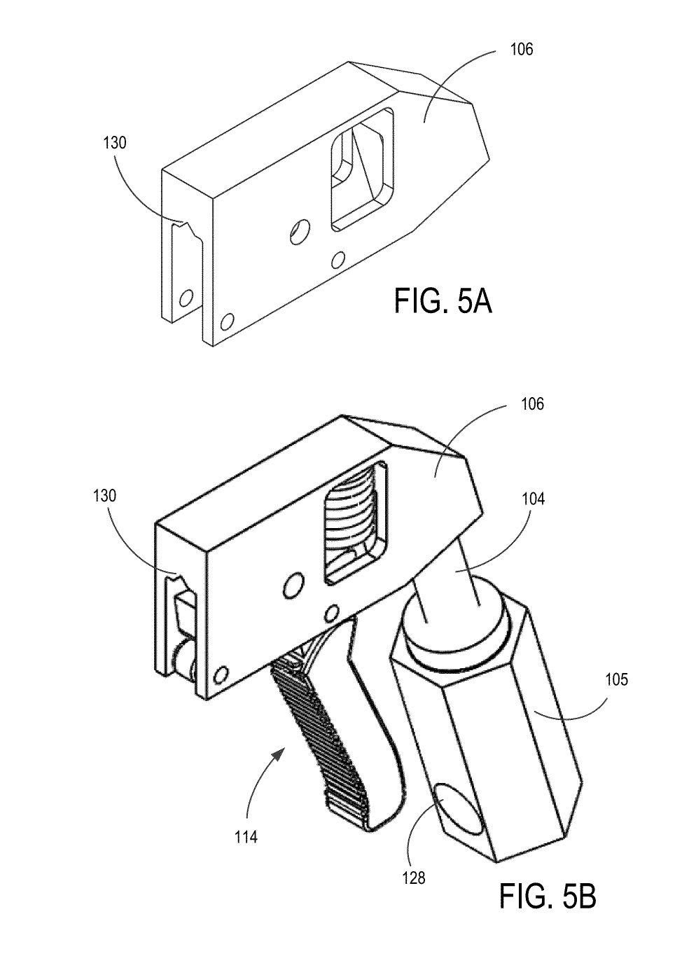

Now referring to FIGS. 5A and 5B, shown are exemplary isometric views of the head stock or frame 106, and the head stock 126 shown in an assembly with a neck 104 connecting the head stock 106 to a mounting base 105 in accordance with an illustrative embodiment. In this illustrative view, a compression spring 126 can be seen through an opening at the side of the head stock 106, to provide access to the compression spring and allow it to be replaced as needed.

In an embodiment, shown at the front part of the head stock 106 is an inner retention surface 124 which is in the shape of a v-groove and is adapted to better receive and hold a consumable electrode rod or stick 200. More particularly, the v-groove shape helps to hold in position a cylindrically shaped consumable electrode rod or stick 200 by providing at least three points of contact—one on each of the walls of the v-groove, and a third provided by a surface of the retention lever. It will be appreciated that the retention lever 113 may also include a v-groove, which may provide four points of contact for a cylindrically shaped consumable electrode rod or stick 200 inserted into the head stock 106. By providing a sufficiently strong resiliently compressible biasing means 126, the consumable electrode rod or stick 200 can be held firmly in position, thereby allowing a suitable amount of force to be applied when urging the consumable electrode rod or stick 200 against a joint being welded.

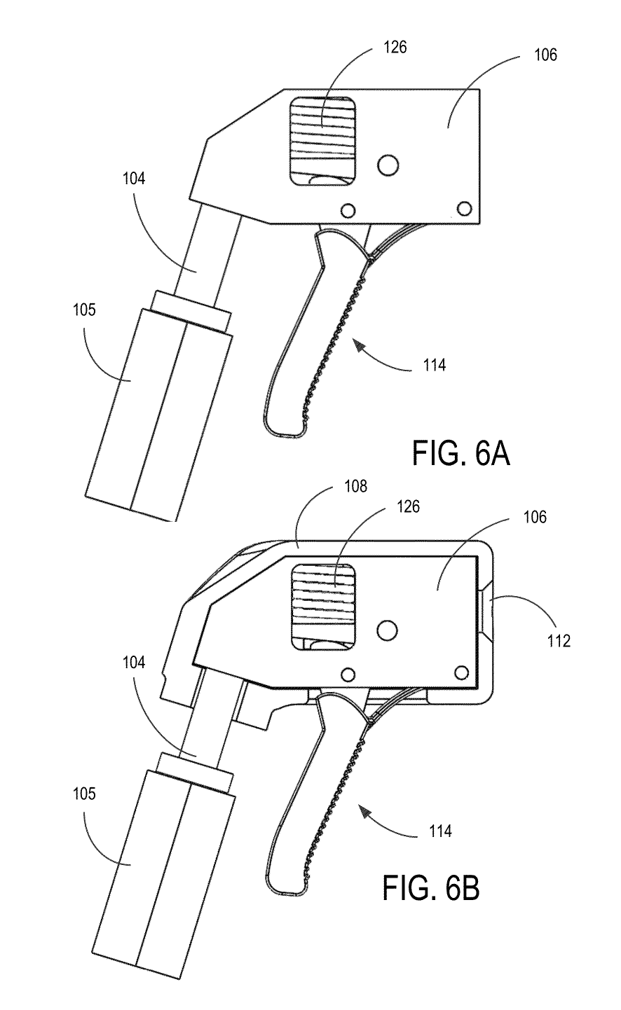

Now referring to FIGS. 6A and 6B, shown are exemplary side views of the head, neck, mounting base and trigger assembly with and without the head casing. As shown in FIG. 6A, all parts including the trigger arm may be made of metal, although the trigger arm must be covered by an overmold if it is also a metal.

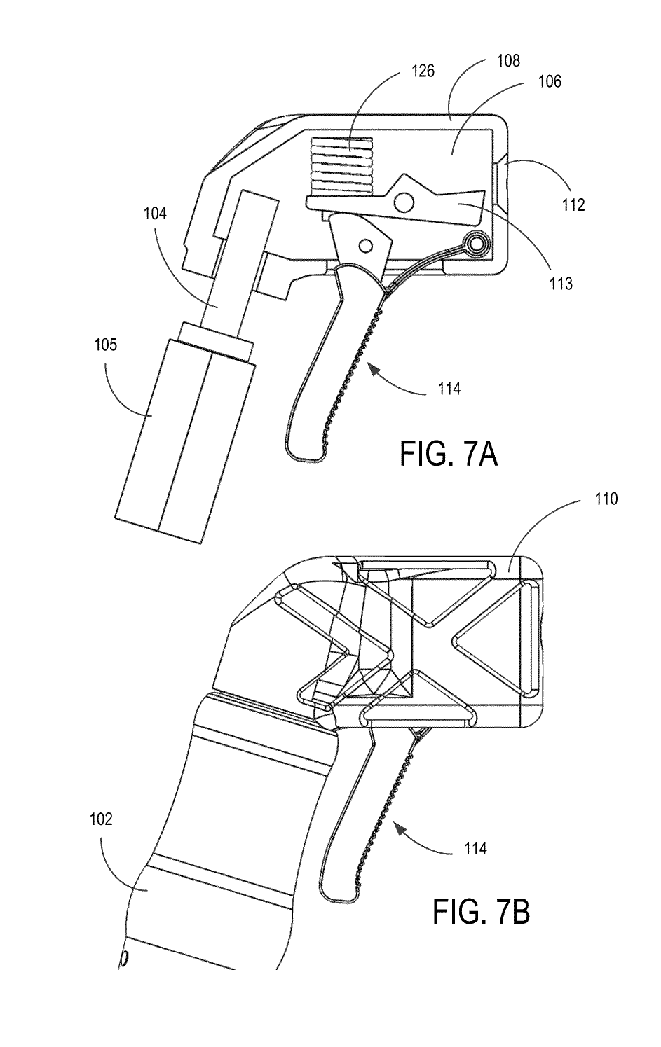

Shown in FIGS. 7A and 7B are exemplary side views of the head, neck, mounting base, trigger, and insulative casings and overmolds providing a protective outer shell in accordance with an illustrative embodiment. In FIG. 7A, the clam shell casing is shown in cross-section encasing the head stock, but providing an opening on the front for receiving a consumable electrode rod or stick. An opening provided on the bottom side of the head stock also allows the trigger arm to be pivotally mounted to the head stock and to allow the trigger arm to be operated by squeezing it.

FIG. 7B shows a view in which the neck and mounting base are fully enclosed in a handle, and in which the head stock is further encased in an overmold or outer shell to provide greater protection against mechanical shocks. FIG. 7B most closely corresponds to the views shown in FIGS. 1A and 1B.

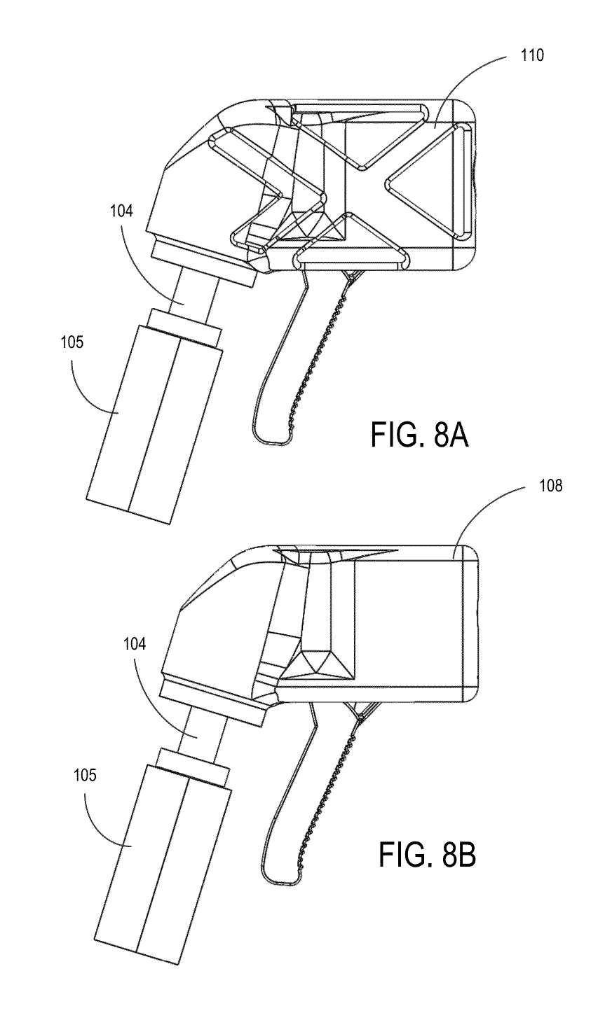

FIGS. 8A and 8B show exemplary side views of the head, neck, mounting base, trigger assembly and head casing, with and without the overmold, corresponding to isometric view shown in FIG. 2.

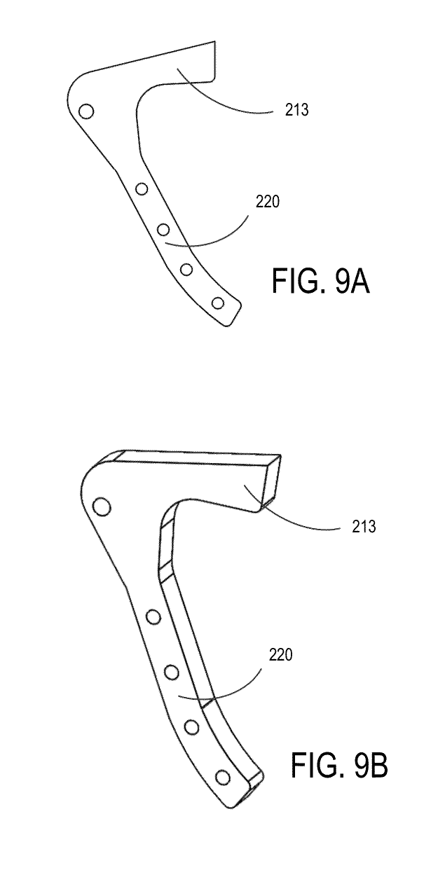

Now referring to FIGS. 9A and 9B, while the retention lever and the trigger are shown in the above illustrative embodiment as being separate pieces, it will be appreciated that in an alternative embodiment the retention lever and trigger may be formed from a single, integral piece to actuate the retention lever. The single piece forming the retention lever and the trigger may be generally L-shaped or T-shaped, for example, with a trigger portion 220, and an integrated retention lever portion 213, and pivotally connected to the head stock 106. The trigger portion 220 may be suitably insulated with a trigger overmold. An illustrative L-shaped piece is shown by way of example in FIGS. 9A and 9B.

Thus, in an aspect, there is provided a welding apparatus, comprising: a head stock; a retention lever pivotally mounted to the head stock; a biasing means adapted to urge the retention lever against a retention surface of the head stock; and a trigger extending from the head stock, the trigger adapted to move the retention lever away from the retention surface of the head stock when operated.

In an embodiment, the head stock and retention lever pivotally mounted to the head stock are electrically conductive, and adapted to provide an electric current to a consumable electrode rod or stick secured by the retention lever against the retention surface of the head stock.

In another embodiment, the apparatus further comprises an electrically insulative casing adapted to electrically insulate the head stock.

In another embodiment, the trigger extending from the head stock is electrically insulated.

In another embodiment, the retention lever and the trigger are formed from a single, integral piece.

In another embodiment, the single, integral piece is generally L-shaped or T-shaped.

In another embodiment, the biasing means comprises a compression spring.

In another embodiment, the apparatus further comprises a neck connecting the head stock to a mounting base, wherein the neck and mounting base are electrically conductive.

In another embodiment, the apparatus further comprises an electrically insulative handle covering the neck and mounting base.

In another embodiment, the trigger extends generally adjacent to the insulative handle such that the trigger may be gripped by an operator with one hand also holding the handle.

In another embodiment, the retention surface of the head stock includes a groove adapted to receive a consumable electrode rod or stick, whereby upon engagement of the retention lever, the consumable electrode rod or stick remains secured in position.

In another embodiment, the retention lever also includes a groove adapted to receive the consumable electrode rod or stick from an opposing side, whereby upon engagement of the retention lever, the consumable electrode rod or stick is secured by multiple surfaces from different angles.

In another embodiment, the groove is generally v-shaped.

While illustrative embodiments have been described above by way of example, it will be appreciated that various changes and modifications may be made without departing from the scope of the invention. Thus, the scope of the invention is defined by the following claims.

1. A welding apparatus, comprising:
a head stock;
a retention lever pivotally mounted to the head stock;
a biasing means adapted to urge the retention lever against a retention surface of the head stock; and
a trigger extending from the head stock, the trigger adapted to move the retention lever away from the retention surface of the head stock when operated.

2. The welding apparatus of claim 1, wherein the head stock and retention lever pivotally mounted to the head stock are electrically conductive, and adapted to provide an electric current to a consumable electrode rod or stick secured by the retention lever against the retention surface of the head stock.

3. The welding apparatus of claim 2, further comprising an electrically insulative casing adapted to electrically insulate the head stock.

4. The welding apparatus of claim 3, wherein the trigger extending from the head stock is electrically insulated.

5. The welding apparatus of claim 1, wherein the retention lever and the trigger are formed from a single, integral piece.

6. The welding apparatus of claim 5, wherein the single, integral piece is generally L-shaped or T-shaped.

7. The welding apparatus of claim 1, wherein the biasing means comprises a compression spring.

8. The welding apparatus of claim 1, further comprising a neck connecting the head stock to a mounting base, wherein the neck and mounting base are electrically conductive.

9. The welding apparatus of claim 8, further comprising an electrically insulative handle covering the neck and mounting base.

10. The welding apparatus of claim 9, wherein the trigger extends generally adjacent to the insulative handle such that the trigger may be gripped by an operator with one hand while also holding the handle.

11. The welding apparatus of claim 1, wherein the retention surface of the head stock includes a groove adapted to receive a consumable electrode rod or stick, whereby upon engagement of the retention lever, the consumable electrode rod or stick remains secured in position.

12. The welding apparatus of claim 11, wherein the retention lever also includes a groove adapted to receive the consumable electrode rod or stick from an opposing side, whereby upon engagement of the retention lever, the consumable electrode rod or stick is secured by multiple surfaces from different angles.

13. The welding apparatus of claim 11, wherein the groove is generally v-shaped.
